(19) United States
(12) Patent Application Publication
(10) Pub. No.: US 2004/0173188 A1
(43) Pub. Date: Sep. 9, 2004

(54) Device for supplying fuel from a tank to an internal combustion engine

(76) Inventor: Hans-Peter Braun, Renfrizhausen (DE)

Correspondence Address: RONALD E. GREIGG, GREIGG & GREIGG P.L.L.C., Suite One, 1423 Powhatan Street, Alexandria, VA, 22314, US

(21) Appl. No.: 10/782,834

(22) Filed: Feb. 23, 2004

(30) Foreign Application Priority Data
Mar. 6, 2003 (DE) 1 03 09 712.0

(51) Int. Cl. F02M 37/04

(52) U.S. Cl. 123/509

(57) ABSTRACT

A device for supplying fuel from a tank in which the mount of the fuel-supply pump, in which the mount is simpler and less expensive than the known devices because the number of components is reduced through the integration of functions. The mount of the fuel-supply pump is embodied as a rigid conduit and has a first fuel supply line section that is connected to the outlet fitting of the fuel-supply pump. The transmission of noise to the mount is reduced.

### BACKGROUND OF THE INVENTION

1. Field of the Invention

The invention is directed to an improved device for supplying fuel from a tank to an internal combustion engine.

2. Description of the Prior Art

A fuel supply device is known from DE 196 19 992 A1, in which a fuel-supply pump is supported with its housing in a cylindrical mount and is fixed in the cylindrical mount by means of a pressurized connection fitting that is slid onto an outlet fitting of the fuel-supply pump. The cylindrical mount is also flexibly supported by noise-damping suspension elements so that noise generated by the fuel-supply pump cannot be transmitted to the tank via the mount. The pressure connection fitting is attached to a main filter of the device via a flexible tube. It is disadvantageous that the mount requires a large amount of space and is comparatively complex and costly.

### OBJECT AND SUMMARY OF THE INVENTION

The device according to the invention has the advantage over the prior art in that the mount of the fuel-supply pump is simplified and in that the mount is embodied as a rigid conduit and has a first fuel supply line section that is connected to the outlet fitting of the fuel-supply pump. In this manner, the first fuel supply line section is integrated into the mount, thus reducing the number of components and reducing the production costs.

It is particularly advantageous to attach the fuel-supply pump to the mount only by means of the outlet fitting since this makes it possible to reduce the transmission of noise to the tank. It also significantly simplifies assembly.

It is also advantageous if the mount has a mount fitting with a mount conduit that feeds with an opening into the first fuel supply line section since this makes it particularly easy to fasten the outlet fitting of the fuel-supply pump in the mount conduit.

It is advantageous if the outlet fitting of the fuel-supply pump is inserted into the mount conduit and passes through a mounting element provided in the connection opening because this produces a positively engaging connection between the mounting element and the outlet fitting.

It is also advantageous if the mounting element engages in detent fashion in a mounting groove of the outlet fitting since this permits the production of a simple and reliable detent connection.

Because the fuel-supply pump is fastened to the outlet fitting only at the mounting element, it is also advantageous to make the mounting element out of an elastic material since this can significantly reduce amount of fuel-supply pump noise that is transmitted to the tank via the mount.

It is very advantageous if the mount has a first shoulder in the connection opening, against which the mounting element rests; a second shoulder fixes the mounting element against the first shoulder in cantilevered fashion. The fuel-supply pump is thus firmly fixed in the mount.

It is also advantageous to fix the mounting element against the first shoulder by means of at least one hold-down element since this also firmly anchors the fuel-supply pump in the mount.

It is additionally advantageous if the mounting element is flat and disk-shaped since this makes the mounting element particularly inexpensive to produce.

It is advantageous to embody the mounting element as a curved shaped part because this facilitates production of the detent connection.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 shows a sectional view of a device incorporating the invention for supplying fuel,

FIG. 2 shows an enlarged, fragmentary three-dimensional view of the device according to FIG. 1,

FIG. 3 shows a first exemplary embodiment of the invention,

FIG. 4 shows a fuel-supply pump with an outlet fitting according to the invention,

FIG. 5 shows a second exemplary embodiment of the invention,

FIG. 6 shows a sectional view of the second exemplary embodiment,

FIG. 7 shows a third exemplary embodiment of the invention, and

FIG. 8 shows a fourth exemplary embodiment.

### DESCRIPTION OF THE PREFERRED EMBODIMENTS

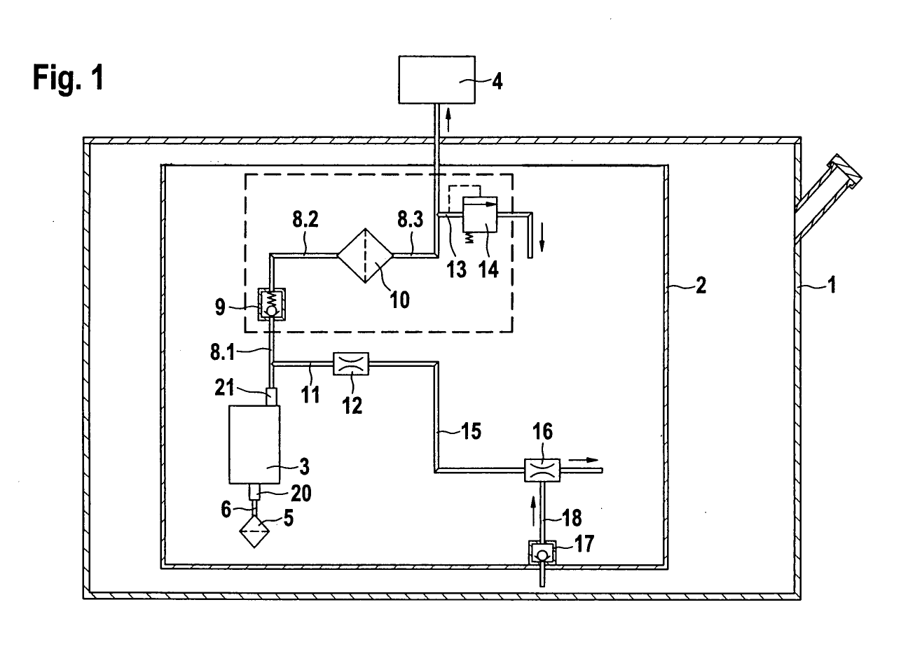

The fuel supply device shown in FIG. 1 serves, for example, to supply fuel from a tank 1 to a collecting receptacle 2 and from there, via a fuel-supply pump 3, to an internal combustion engine 4 of a motor vehicle.

The tank 1 contains the collecting receptacle 2, which in turn contains the fuel-supply pump 3. The for example cup-shaped collecting receptacle 2 stores enough fuel to assure a sufficient supply of fuel to the internal combustion engine 4 by means of the fuel-supply pump 3 even when no fuel is being supplied into the collecting receptacle 2, for example because the vehicle is negotiating a curve and thus causing sloshing movements of the fuel in the tank 1.

The fuel-supply pump 3 draws fuel from the collecting receptacle 2, for example via a prefilter 5 and an intake line 6, and supplies the fuel to the internal combustion engine 4, for example via a first fuel supply line section 8.1, a check valve 9, a second fuel supply line section 8.2, a main filter 10, and a third fuel supply line section 8.3

Starting from the third fuel supply line section 8.3, an excess pressure line 13 leads to a pressure regulating valve 14. If the pressure in the third fuel supply line section 8.3 and therefore in the excess pressure line 13 exceeds a preset pressure, then the pressure regulating valve 14 opens and allows fuel to flow back into the collecting receptacle 2 via the excess pressure line 13 and the pressure regulating valve 14. This reduces the pressure in the third fuel supply line section 8.3 back to below the preset pressure and the pressure regulating valve 14 closes again.

For example, the fuel-supply pump 3 is a flow-type pump that is driven electrically by an actuator, for example an armature of an electric motor.

The prefilter 5 protects the device downstream of the prefilter 5 from coarse particulate matter contained in the fuel.

When the fuel-supply pump 3 is switched off, the check valve 9 prevents fuel from flowing back out of the fuel supply line (8.3, 8.2) downstream of the check valve 9 and into the collecting receptacle 2 via the first fuel supply line section 8.1, the fuel-supply pump 3, the intake line 6, and the prefilter 5.

The main filter 10 filters out the fine particulate matter contained in the fuel.

The first fuel supply line section 8.1 is connected to the collecting receptacle 2 for example via a branch line 11, a throttle 12, a propulsion line 15, and a so-called aspirating jet pump 16.

In order to prevent the fuel-supply pump 3 from emptying the collecting receptacle 2, there must be a continuous replenishing flow of fuel from the tank 1 into the collecting receptacle 2. To this end, the aspirating jet pump 16 draws fuel from the tank 1 for example via a bottom valve 17 and an intake conduit 18. The aspirated fuel is conveyed into the collecting receptacle 2 along with the so-called propulsion jet of the propulsion line 15.

An aspiration jet pump is known, for example, from DE 198 56 298 C1, the disclosure of which is incorporated herein by reference.

The fuel-supply pump 3 has a housing with an inlet fitting 20 and an outlet fitting 21. The intake line 6 is connected to the inlet fitting 20, while the outlet fitting 21 is connected to the first fuel supply line section 8.1.

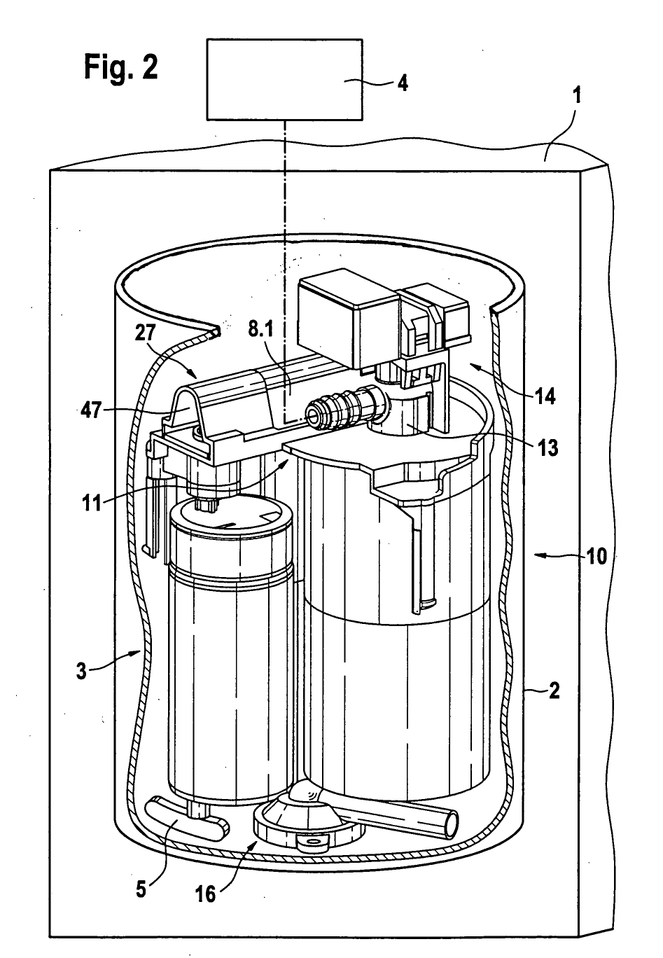

FIG. 2 shows a three-dimensional view of the device according to the invention from FIG. 1.

In the device according to FIG. 2, parts that are the same or function in the same manner as those in the device according to FIG. 1 are provided with the same reference numerals.

The fuel-supply pump 3 is fastened to a mount 27 that is embodied as a rigid conduit. The mount 27 contains the first fuel supply line section 8.1. The end of the mount 27 oriented toward the main filter 10 is connected to the main filter 10. The length of the mount 27 extends beyond the edge of the main filter 10 in the direction of the fuel-supply pump 3. The fuel-supply pump 3 is fastened into the mount 27 by means of a detent connection.

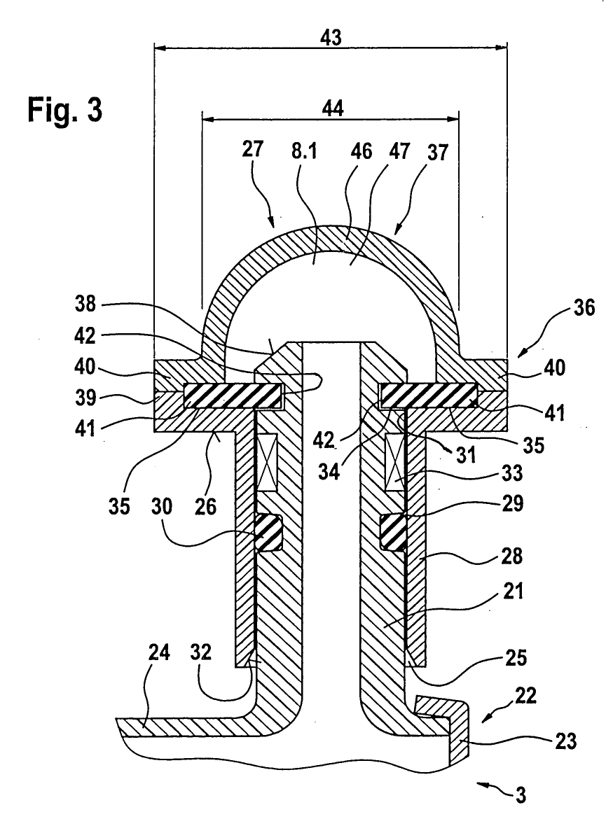

FIG. 3 shows a partial section through a first exemplary embodiment.

In the device according to FIG. 3, parts that are the same or function in the same manner as those in the device according to FIGS. 1 and 2 are provided with the same reference numerals.

For example, the fuel-supply pump 3 has a housing 22 with a cylindrical housing section 23, whose end oriented toward the inlet fitting 20 is sealed shut by a pump cover and whose end oriented toward the outlet fitting 21 is sealed shut by an outlet cover 24.

The end of the mount 27 oriented toward the fuel-supply pump 3 has a mount fitting 28 that is cylindrical, for example. The mount fitting 28 has a mount conduit 25 that feeds from the end of the mount fitting 28 oriented toward the fuel-supply pump 3, through a connection opening 31, and into the first fuel supply line section 8.1. The cross section of the mount fitting 28 is slightly greater than the cross section of the outlet fitting 21 of the fuel-supply pump 3 so that the outlet fitting 21 can be slid into the mount conduit 25 of the mount fitting 28. At the end oriented toward the fuel-supply pump 3, the mount fitting 28 has a first bevel 32 to facilitate the insertion of the outlet fitting 21. The cross section of the mount fitting 28 is circular, for example.

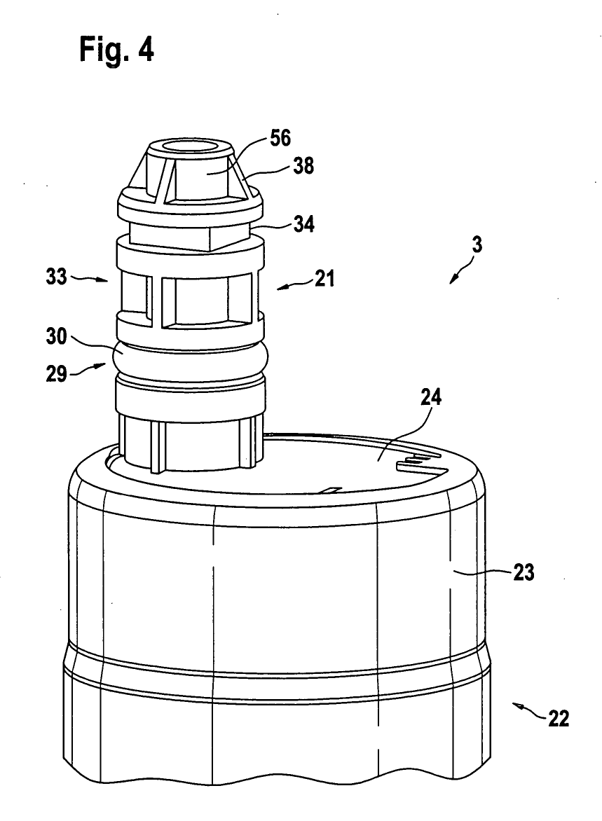

The outer circumference of outlet fitting 21 of the fuel-supply pump 3 has an annular sealing groove 29 in which a sealing ring 30, for example an O-ring, is provided. Downstream of the sealing groove 29, a number of pocket-shaped recesses 33 are provided on the outer circumference of the outlet fitting 21, for example distributed over its circumference. Further downstream of the pocket-shaped recesses 33, the outer circumference of the outlet fitting 21 is provided with a mounting groove 34 that extends around its entire circumference. The mounting groove 34 is round, for example, or is embodied as a square groove (FIG. 4). The outlet fitting 21 is provided with a conical bevel 38 at its end oriented away from the outlet cover 24.

The cross section of the first fuel supply line section 8.1 is composed, for example, of a rectangle 36 and a circular or arcuate segment 37. The cross section of the first fuel supply line section 8.1, however, can also be composed of only the circular segment 37, or can be entirely circular, rectangular, or elliptical.

The transition from the mount fitting 28 to the first fuel supply line section 8.1 forms a first shoulder 35. The first shoulder 35 is adjoined by second shoulder 39 that is of one piece with it and embraces a mounting element 41 that rests against the first shoulder 35 in cantilevered fashion. The second shoulder 39 fixes the mounting element 41 on the first shoulder 35. A width 43 of the rectangle 36 in the vicinity of the connection opening 31 is greater than a diameter 44 of the circular segment 37 so that the first shoulder 35 and the second shoulder 39 together constitute an indentation 40.

For example, the mounting element 41 is embodied as disk-shaped. The mounting element 41 is polygonal, for example square, hexagonal, or octagonal, with respective pairs of parallel sides; two parallel, opposing sides rest against the second shoulder 39 so that the mounting element 41 is supported in a non-rotating fashion in the first fuel supply line section 8.1. The mounting element 41 can, however, also be circular or elliptical. The mounting element 41 is made of an elastic material, for example rubber.

The mounting element 41 has a for example square opening 42 that is smaller than the connection opening 31. The opening 42, however, can also be circular or polygonal.

The mounting element 41 is slid into the indentation 40 through a lateral conduit opening 47. The width 43 of the rectangle 36 is reduced in step fashion in the axial extension of the first fuel supply line section 8.1, thus forming a stop for the mounting element 41. The stop centers the mounting element 41 in relation to the connection opening 31 of the mount fitting 28 so that the opening 42 of the mounting element 41 is concentric to the connection opening 31. After the insertion of the mounting element 41, a side cover 46 closes the lateral conduit opening 47.

In order to attach the fuel-supply pump 3 to the mount 27, the outlet fitting 21 of the fuel-supply pump 3 is slid into mount fitting 28 provided with the mounting element 41. The outlet fitting 21 is pushed, with its bevel 38 first, through the opening 42 of the mounting element 41. As a result, first the bevel 38 elastically stretches the opening 42 until it is the same size as the outer diameter of the outlet fitting 21 and then the outlet fitting 21 travels further through the opening 42 until the mounting groove 34 of the outlet fitting 21 reaches the opening 42. Since the outer diameter of the outlet fitting 21 decreases in step fashion at the mounting groove 34, the elastically stretched opening 42 contracts again, fits elastically into the inner diameter of the mounting groove 34, and thus engages in the mounting groove 34 in detent fashion. As a result, the outlet fitting 21 extends through the opening 42 of the mounting element 41 as it engages in the mount fitting 28. This detent connection attaches the fuel-supply pump 3 to the mount 27. If the opening 42 is square and the mounting groove 34 is a square groove, then this produces a non-rotating detent connection.

The mounting element 41 absorbs virtually all of the forces acting in the direction of the mount fitting 28, for example the weight of the fuel-supply pump, and transmits them to the mount 27. The elasticity of the mounting element 41 damps both mechanical vibrations and acoustical vibrations. Consequently, hardly any acoustical vibrations (noise) that are generated by the fuel-supply pump 3 are transmitted by mounting element 41 to the mount 27, thus permitting a reduction in the audible noise level of the fuel-supply pump 3 in the vehicle.

The sealing ring 30 in the sealing groove 29 seals a gap between the outlet fitting 21 and the mount fitting 28 so that, for example, no fuel can escape from the first fuel supply line section 8.1 to the outside.

FIG. 4 shows the fuel-supply pump 3 with the outlet fitting 21.

In the device according to FIG. 4, parts that are the same or function in the same manner as those in the device according to FIGS. 1 and 3 are provided with the same reference numerals.

The outlet fitting 21 can have additional pocket-shaped recesses 56 distributed over the circumference of its bevel 38.

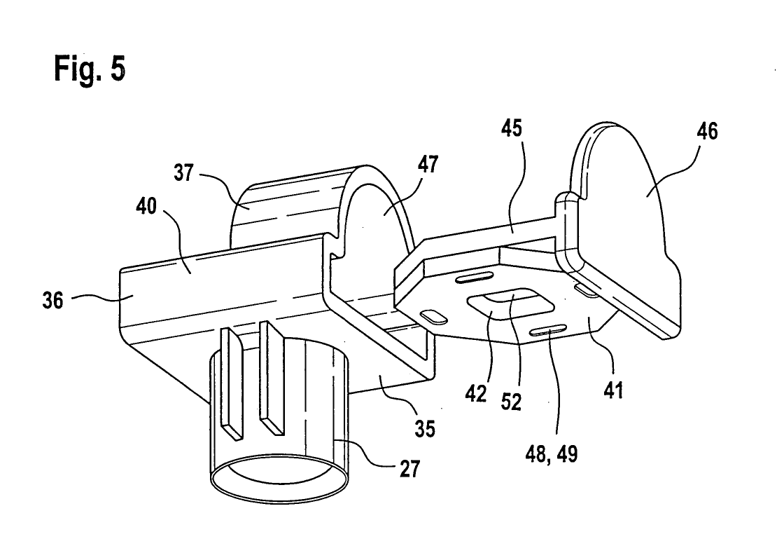

FIG. 5 shows a second exemplary embodiment of the device according to the invention, without a fuel-supply pump 3.

In the device according to FIG. 5, parts that are the same or function in the same manner as those in the device according to FIGS. 1 to 4 are provided with the same reference numerals.

The device according to FIG. 5 differs from the device according to FIG. 3 in that a centering plate 45 disposed perpendicular to the side cover 46 positions the mounting element 41 centrally in relation to the connection opening 31.

As in the exemplary embodiment according to FIG. 3, after the insertion of the mounting element 41, the side cover 46 covers the lateral conduit opening 47 of the mount 27 and seals it off from the environment. The centering plate 45 disposed on the side cover 46 has for example protruding centering means 48 that are disposed, for example, uniformly distributed around the circumference of an additional opening 52 in the centering plate 45. The additional opening 52 in the centering plate 45 is larger than the opening 42 of the mounting element 41. The mounting element 41 is slid onto the centering plate 45 of the side cover 46; the centering means 48, for example centering pins or centering ribs, engage in centering openings 49 of the mounting element 41.

The centering plate 45 is slid with the mounting element 41 into the indentation 40 of the mount 27 until the side cover 46 closes the side conduit opening 47. After the insertion, the centering plate 45 is approximately parallel to the first shoulder 35. The mounting element 41 rests against the shoulder 35. For example, the side cover 46 is welded to the mount 27. However, the side cover 46 can also be glued or flange-mounted to the wall of the lateral conduit opening 47.

Then the outlet fitting 21 of the fuel-supply pump 3 can be slid into the mount fitting 28. The centered mounting element 41 permits the outlet fitting 21 to reliably and simply engage in detent fashion in the mount 27, as described above.

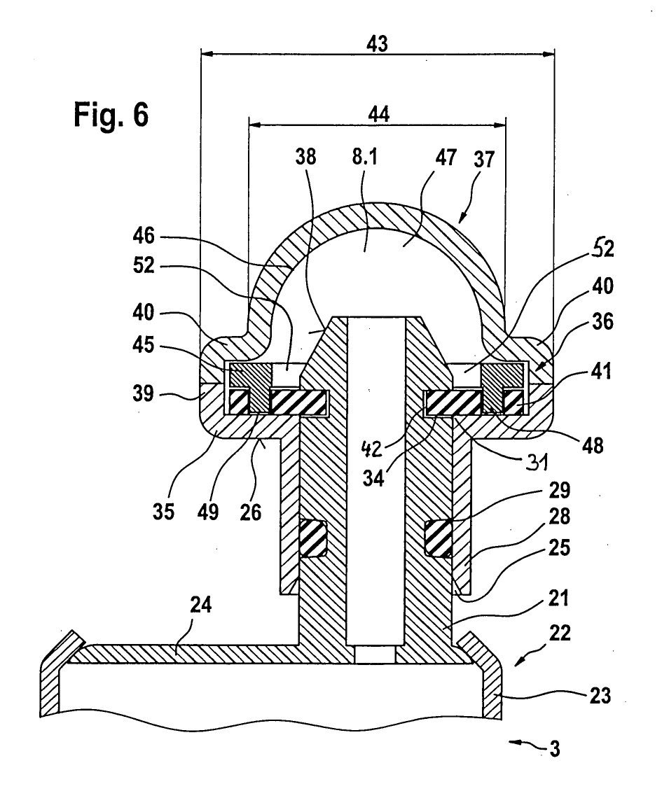

FIG. 6 shows the second exemplary embodiment in a partial sectional view, with the outlet fitting 21 of the fuel-supply pump 3 detent engaged in the mount 27.

In the device according to FIG. 6, parts that are the same or function in the same manner as those in the device according to FIGS. 1 to 5 are provided with the same reference numerals.

After being inserted, the outlet fitting 21 engages in detent fashion in the mount fitting 28 and reaches through both the opening 42 and the additional opening 52. In order to accommodate the centering plate 45, the indentation 40 is taller in the direction of the mount fitting 28 than the indentation 40 in the first exemplary embodiment according to FIG. 3.

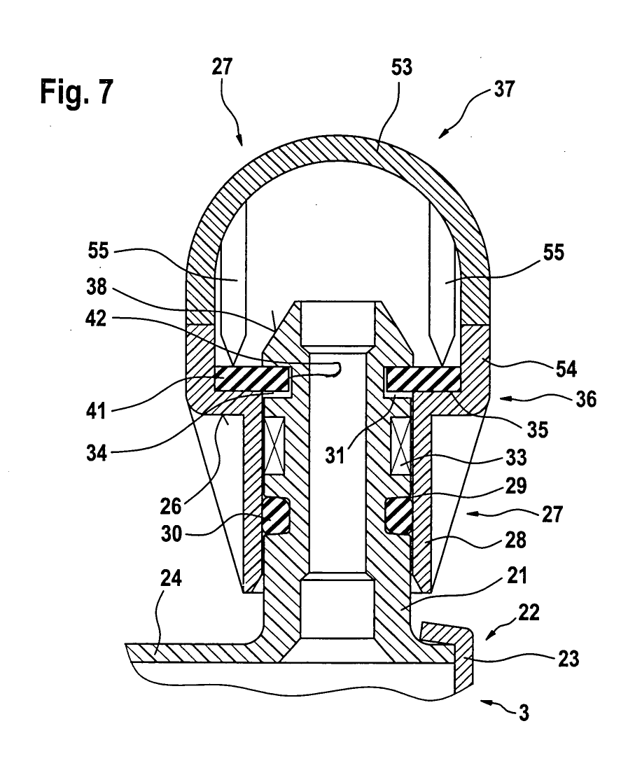

FIG. 7 shows a partial sectional view of a third exemplary embodiment.

In the device according to FIG. 7, parts that are the same or function in the same manner as those in the device according to FIGS. 1 to 6 are provided with the same reference numerals.

The device according to FIG. 7 differs from the device according to FIG. 3 in that the mounting element 41 is fixed against the first shoulder 35 not by the second shoulder 39, but by hold-down elements 55. The second shoulder 39 is eliminated in this third exemplary embodiment.

The mount 27 is divided in the axial direction and is comprised of an upper part 53 with the circular segment 37 and a lower part 54 with the mount fitting 28 and the first shoulder 35. The hold-down elements 55 are disposed on the side of the upper part 53 oriented toward the lower part 54, protrude toward the first shoulder 35 of the lower part 54, and rest against the mounting element 41 so that the mounting element 41 is fixed against the first shoulder 35.

The division in two of the first fuel supply line section 8.1 makes it possible for the holding element 41 to be inserted into the lower part 54 of the mount 27. After the insertion of the mounting element 41, the upper part 53 is slid into the lower part 54 and, for example, welded or glued in place. However, the upper part 53 and the lower part 54 can also be clipped to each other. A separate side cover 46 is not required since it is already formed onto the upper part 53 or the lower part 54.

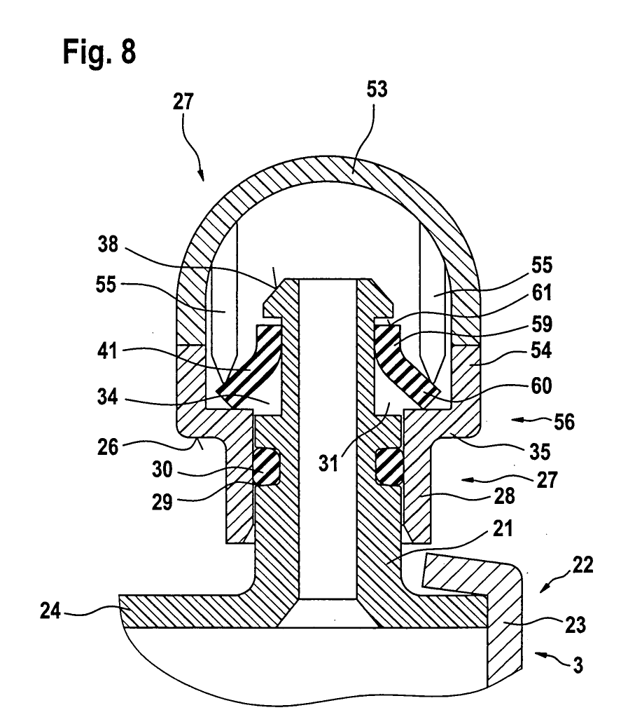

FIG. 8 shows a sectional view of a fourth exemplary embodiment.

In the device according to FIG. 8, parts that are the same or function in the same manner as those in the device according to FIGS. 1 to 7 are provided with the same reference numerals.

The device according to FIG. 8 differs from the device according to FIG. 7 in that the mounting element 41 is not embodied as flat, but as a curved shaped part. To this end, the elastic mounting element 41 is produced, for example, by means of injection molding. An inner region 59 of the mounting element 41 encompasses the opening 42; an outer region 60 constitutes the outer circumference of the mounting element 41 and is spaced apart in the axial direction from the inner region 59 due to the curvature of the mounting element 41.

The mounting element 41 rests with its inner region 59 in the mounting groove 34 and rests with its outer region 60 against the first shoulder 35. The mounting groove 34 is embodied as longer in the direction of the outlet fitting 21 than those according to FIGS. 3, 5, 6, and 7 since starting from the inner region 59, the mounting element 41 in the mounting groove 34 extends first in the direction of the outlet fitting 21 and then curves outward in the direction of the first shoulder 35. The hold-down elements 55 protrude in the direction of the first shoulder 35 and press the inner region 59 into the mounting groove 34 while pressing the outer region 60 of the mounting element 41 against the first shoulder 35. The inner region 59 of the mounting element 41 rests against an upper side surface 61 of the mounting groove 34. The forces of the fuel-supply pump 3 act on the inner region 59 of the mounting element 41 via the upper side surface 61 and are transmitted to the mount 27 via the first shoulder 35.

The foregoing relates to preferred exemplary embodiments of the invention, it being understood that other variants and embodiments thereof are possible within the spirit and scope of the invention, the latter being defined by the appended claims.

I claim:

1. In a device for supplying fuel from a tank to an internal combustion engine, including a fuel-supply pump having an outlet fitting and being fastened by means of a mount, the improvement wherein the mount (27) is embodied as a rigid conduit having a first fuel supply line section (8.1) connected to the outlet fitting (21) of the fuel-supply pump (3).

2. The device according to claim 1, wherein the fuel-supply pump (3) is fastened to the mount (27) by means of the outlet fitting (21).

3. The device according to claim 1, wherein the mount (27) comprises a mount fitting (28) with a mount conduit (25) that feeds with a connection opening (31) into the first fuel supply line section (8.1).

4. The device according to claim 3, wherein the outlet fitting (21) of the fuel-supply pump (3) is inserted into the mount conduit (25) and extends through a mounting element (41) provided in the connection opening (31).

5. The device according to claim 4, wherein the outlet fitting (21) comprises a mounting groove (34), and wherein the mounting element (41) engages the mounting groove (34) in detent fashion.

6. The device according to claim 4, wherein the mounting element (41) is made of an elastic material.

7. The device according to claim 4, wherein the mounting element (41) is flat and disk-shaped.

8. The device according to claim 4, wherein the mounting element (41) is a curved shaped part.

9. The device according to claim 4, wherein in the connection opening (31), the mount (27) comprises a first shoulder (35) against which the mounting element (41) rests, and a second shoulder (39) fixing the mounting element (41) against the first shoulder (35) in cantilevered fashion.

10. The device according to claim 4, wherein in the connection opening (31), the mount (27) comprises a first shoulder (35) against which the mounting element (41) rests, and at least one hold-down element (55) fixing the mounting element (41) against the first shoulder (35).
